(19) United States
(12) Patent Application Publication
(10) Pub. No.: US 2010/0063921 A1
(43) Pub. Date: Mar. 11, 2010

(54) System and method for performing lease-by-lease cash flow and risk analysis in the commercial backed securities (CMBS) environment

(76) Inventor: James E. Flaherty, Sausalito, CA (US)

Correspondence Address: STEVEN A. NIELSEN;ALLMAN & NIELSEN, P.C., 100 Larkspur Landing Circle, Suite 212, LARKSPUR, CA, 94939, US

(21) Appl. No.: 12/207,875

(22) Filed: Sep. 10, 2008

(51) Int. Cl. G06Q 50/00; G06Q 40/00

(52) U.S. Cl. 705/38

(57) ABSTRACT

Participants to the commercial mortgage backed securities (CMBS) market enter data unique to their property via a web-based application that applies underwriting assumptions and/or methods of transforming income and expense information into a format acceptable to the CMBS industry. The resulting data set is suitable for analysis by lenders, third party credit rating companies, and investors thus standardizing and simplifying the process of obtaining a loan, the need for lenders to perform standardized underwriting analysis, and the transfer of this analysis to both the rating agencies and the investors. The disclosed methods and procedures greatly simplify how loans enter into the CMBS market and how investors analyze the performance of loans already in the CMBS market.

### CROSS-REFERENCE TO RELATED APPLICATIONS

Not Applicable

### BACKGROUND

(1) Field of the Invention

Generally, the invention relates to means and methods of cash flow analysis for both single and multiple properties with income streams offered as collateral in a commercial mortgage backed security. More particularly, the invention relates to methods of modeling underwriting assumptions used to evaluate the income or potential income of a commercial property and how that property's income affects the performance of the related debt instruments and bonds that are part of the securitized pool of loans.

(2) Description of the Related Art

Several attempts to present Internet based means of evaluating proposed loans are known in the related art. However, the related art fails to provide the advantages of the present invention.

U.S. Pat. No. 6,985,881 METHODS AND APPARATUS FOR AUTOMATED UNDERWRITING OF SEGMENTABLE PORTFOLIO ASSETS granted to Johnson et al on Jan. 10, 2006 attempts to provide rapid evaluation of financial instruments but fails to consider or solve problems with underwriting assumptions related to cash flow analysis.

U.S. Pat. No. 7,249,146 COMPUTER SYSTEM AND METHOD FOR ACQUIRING AND ANALYZING DATA PERTAINING TO REAL ESTATE granted to Brecher on Jul. 24, 2007 attempts to provide methods to compare income and expenses of similar properties, but fails to consider multiple scenarios of tenant occupancy rates or varying lease rates.

U.S. Pat. No. 7,165,043 VALUATION PREDICTION MODELS IN SITUATIONS WITH MISSING INPUTS granted to Keyes et al on Jan. 16, 2007 attempts to evaluate large groups of assets with partial sample underwriting wherein missing data elements are artificially estimated by the use of statistical evaluation. Keyes fails to consider the use multiple estimates of vacancy rates or lease rates in evaluating potential income streams of commercial property.

The related art fails to address the income modeling procedures or underwriting involved in assessing the income streams of commercial properties. The occasional upswing in mortgage defaults may be attributed to the failure in the related art to accurately assess or evaluate present and/or future income streams of commercial property.

Unlike the transactions contemplated in the related art, a loan on a commercial property with an exit strategy of selling the loan in a commercial mortgage backed security (“CMBS”) may comprise a multitude of pooled loans. Each loan or tranche of a loan requires a detailed cash flow analysis by the issuer, a third party rating agency, and the investors.

With the dramatic increase in commercial mortgage backed securities and the desire of lenders, rating agencies, and investors to use the Internet and other electronic means to originate loans, evaluate income streams, and to pool loans to create bonds and other financial instruments, there is a need in the art for new underwriting methodologies suitable for web-based use.

### BRIEF SUMMARY

The present invention, sometimes referred to herein as “CMBS.com” “the system” or “the invention” overcomes shortfalls in the related art by presenting a web-based interface with stored procedures and underwriting assumptions that facilitate loan origination, credit decisions, creation of securitizations, and risk assessment for loans that might be used in commercial mortgage backed securities. The invention may also provide an analysis of the securities themselves. Unlike the related art, the present invention is focused on the specific needs of commercial property owners, lenders, rating agencies and investors who are interested in creating and analyzing loans suitable for inclusion in a CMBS instrument.

The invention overcomes shortfalls in the art by evaluating income streams or the present value of a commercial property with the use of variable and multiple underwriting assumptions that may be proposed or entered into the system by a property owner, lender, potential investor, or system operator. Thus, unlike the related art, the invention allows for users to input multiple underwriting assumptions to account for different possibilities in vacancy rates, rent rates, market conditions, ROI expectations, and other future values that may be estimated by users of the system.

CMBS.com provides means and methods for presenting commercial property rent rolls, operating statements, and other data through underwriting methods, procedures, and assumptions to create loan proposals suitable for analysis using the standard metrics of the CMBS industry.

Specifically, the use of the underwriting assumptions and the disclosed methods of CMBS.com transform the input of information unique to each commercial property and its related debt, operating statements, tenancies and other variables into formats or data structures acceptable to the CMBS industry. The resulting data streams are acceptable for use in assessing risk, creating loans, creating securitizations of pooled loans, and analyzing existing pools of secured loans.

These and other objects and advantages will be made apparent when considering the following detailed specification when taken in conjunction with the drawings.

### BRIEF DESCRIPTION OF THE DRAWINGS

FIG. 1 is a flow chart of the general underwriting structure

FIG. 2 is a pseudo screen shot of a Notes interface

FIG. 3 is a pseudo screen shot of a Property Information interface

FIG. 4 is a pseudo screen shot of an Underwriting Assumption—Header interface

FIG. 5 is a pseudo screen shot of an Underwriting Assumption—Detail interface

FIG. 6 is a pseudo screen shot of an Underwriting Cash Flow (UCF) interface

FIG. 7 is a pseudo screen shot of a Multi Year Underwritten Assumption Details page

FIG. 8 is a pseudo screen shot of a Multi Year Cash Flow Page FIGS. 9A and 9B are pseudo screen shots of a Securitization Analysis Page

### DETAILED DESCRIPTION

The description, which follows, and the embodiments described therein, are provided by way of illustration of an example, or examples of particular embodiments of the principles of the present invention. These examples are provided for the purposes of explanation, and not of limitation, of those principles of the invention. In the description, which follows, like parts are marked throughout the specification and the drawings with the same respective reference numerals.

### REFERENCE NUMBERS

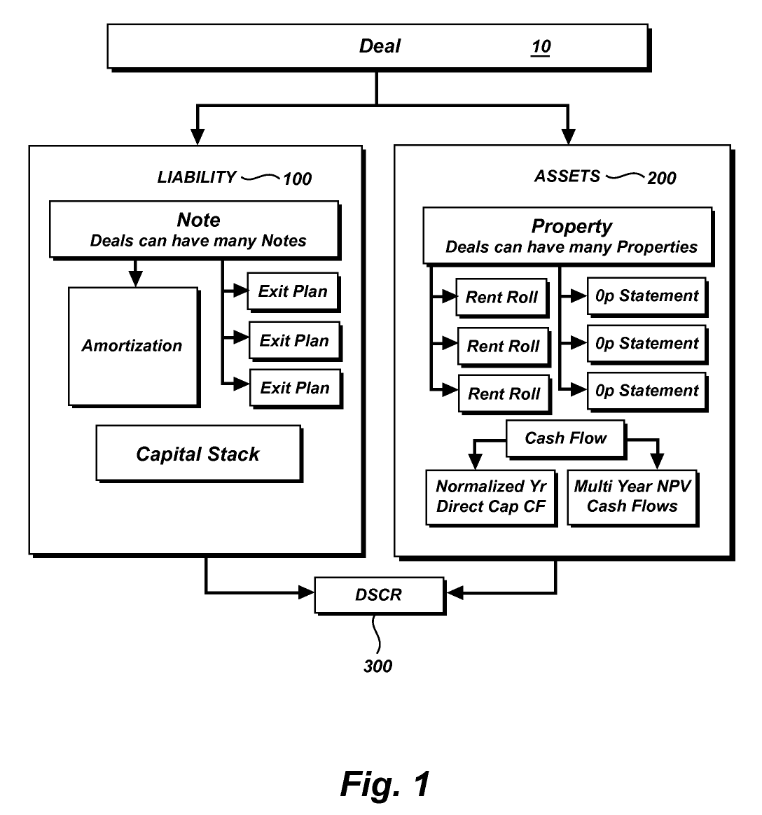

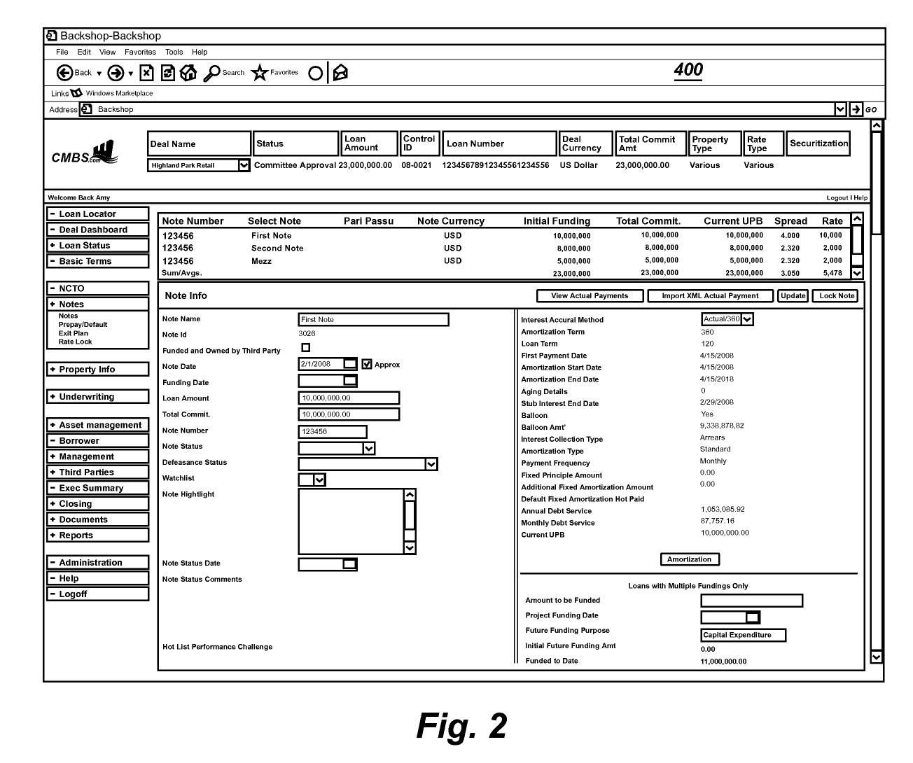

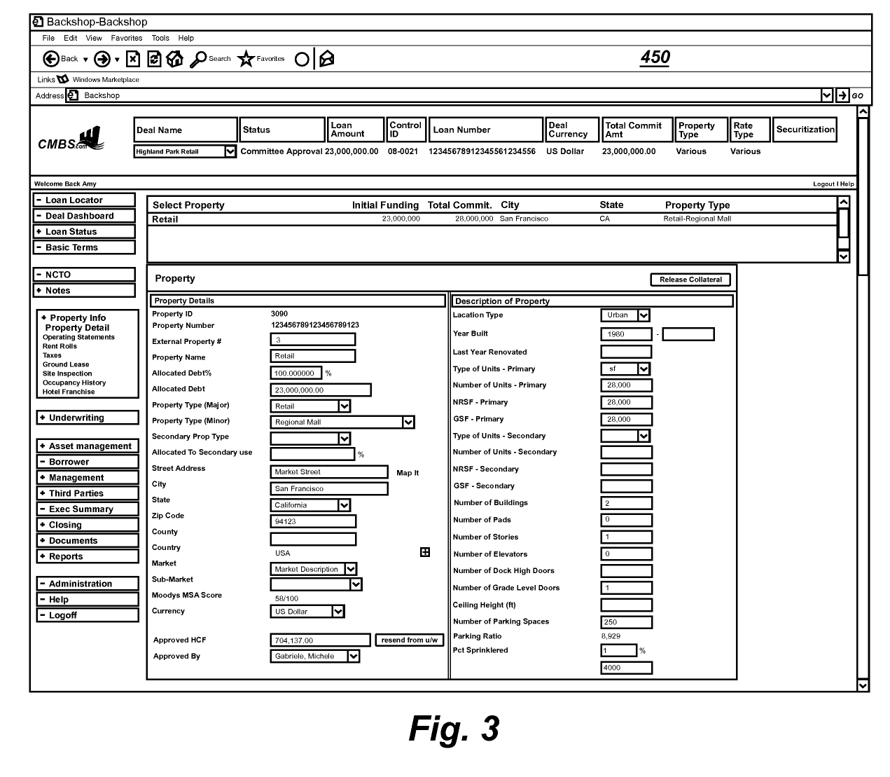

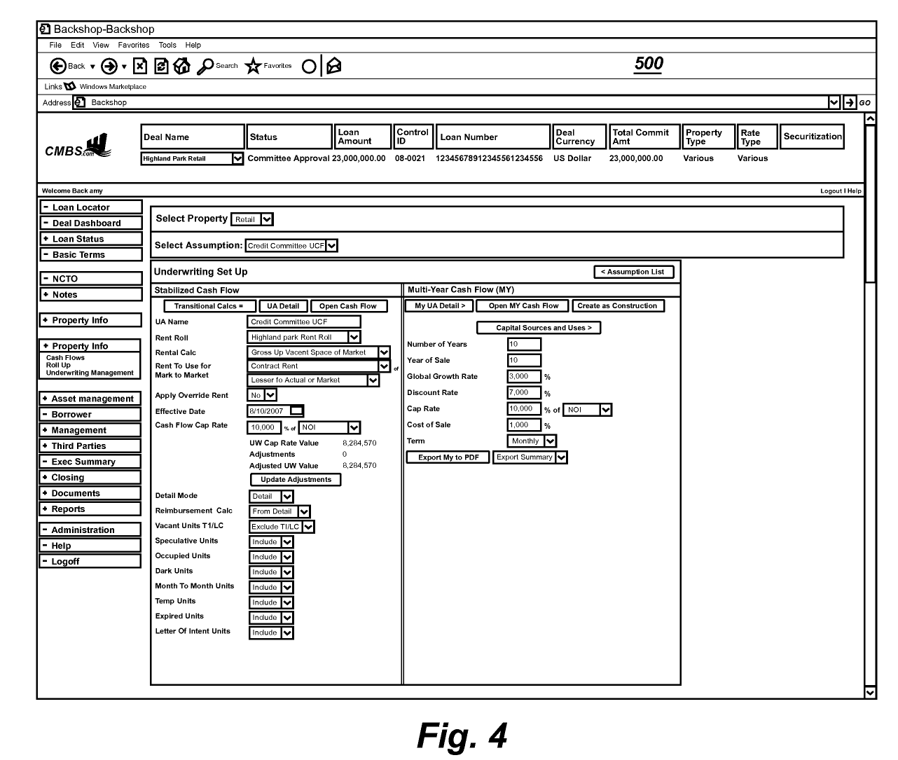

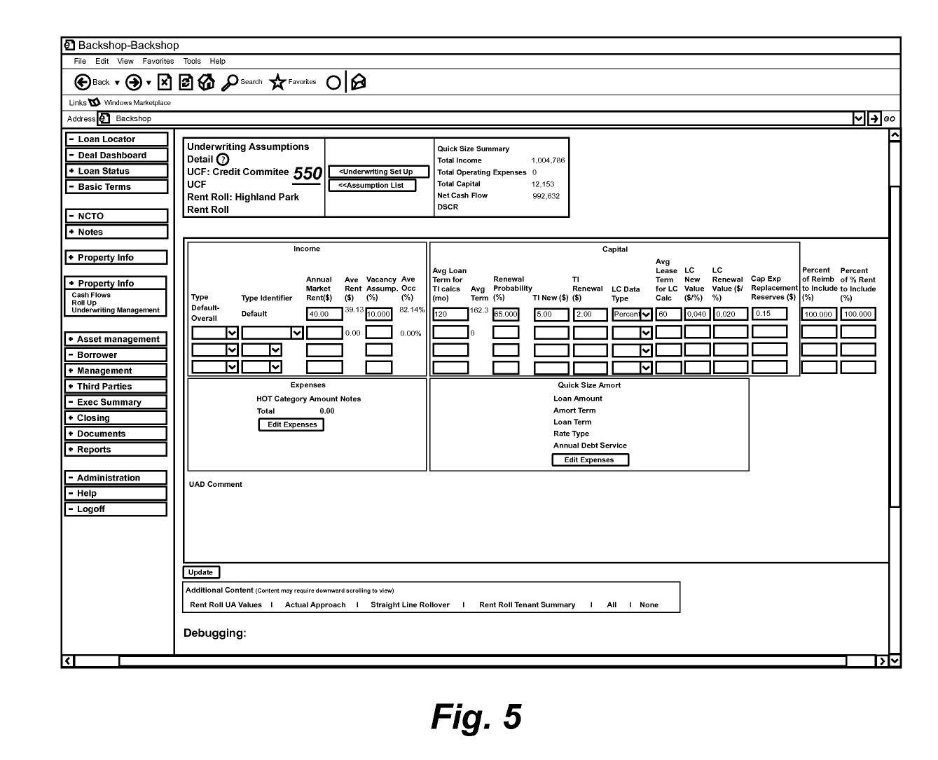

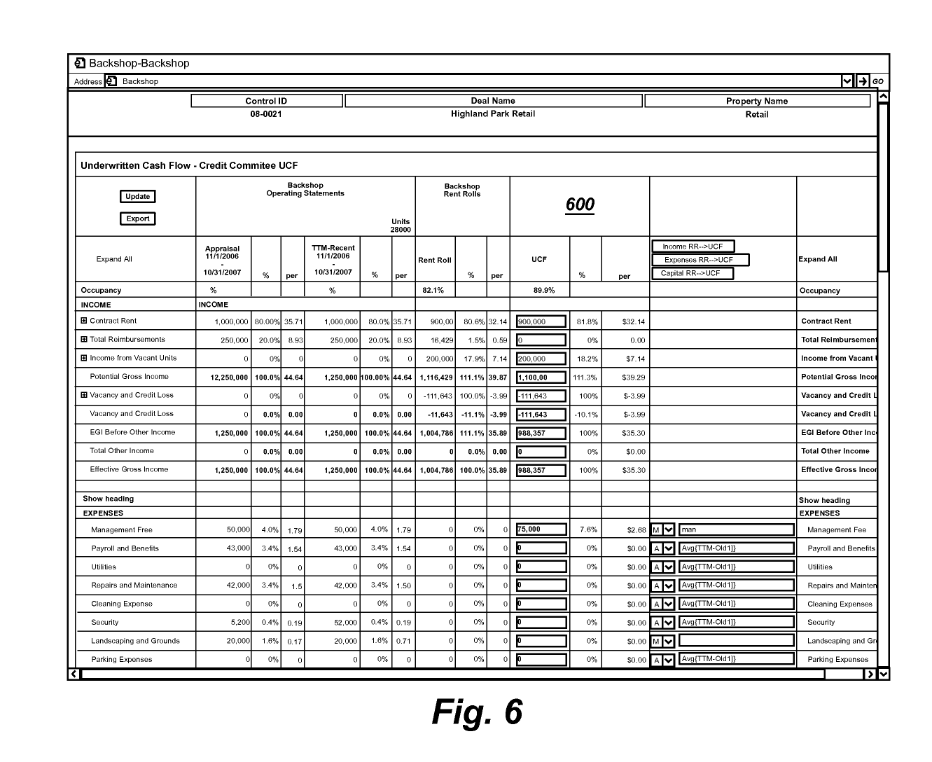

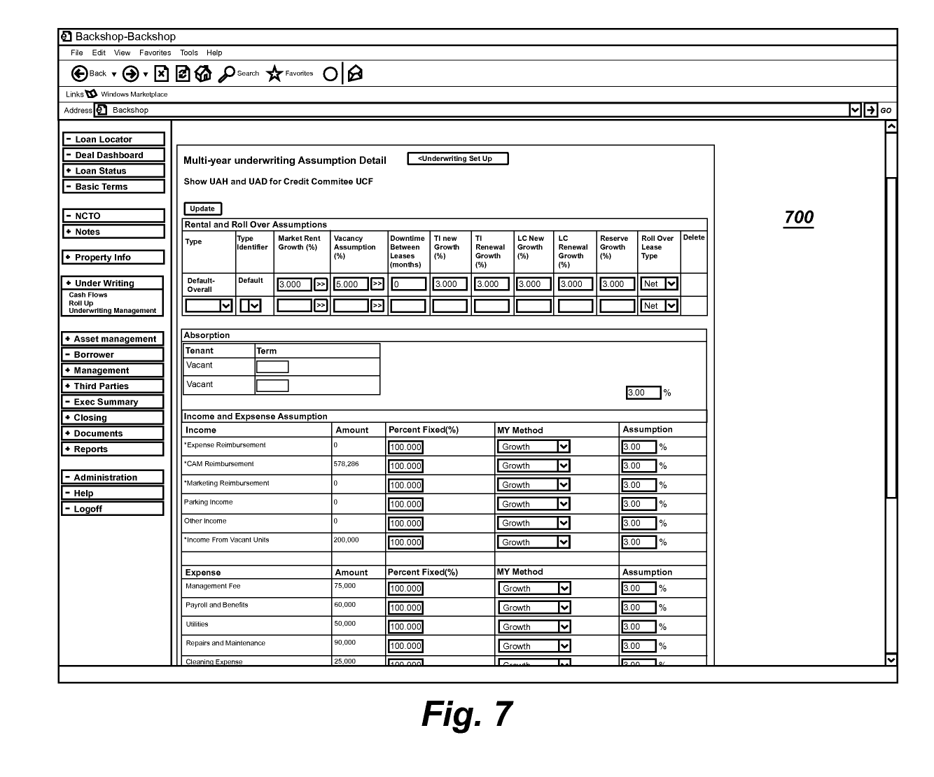

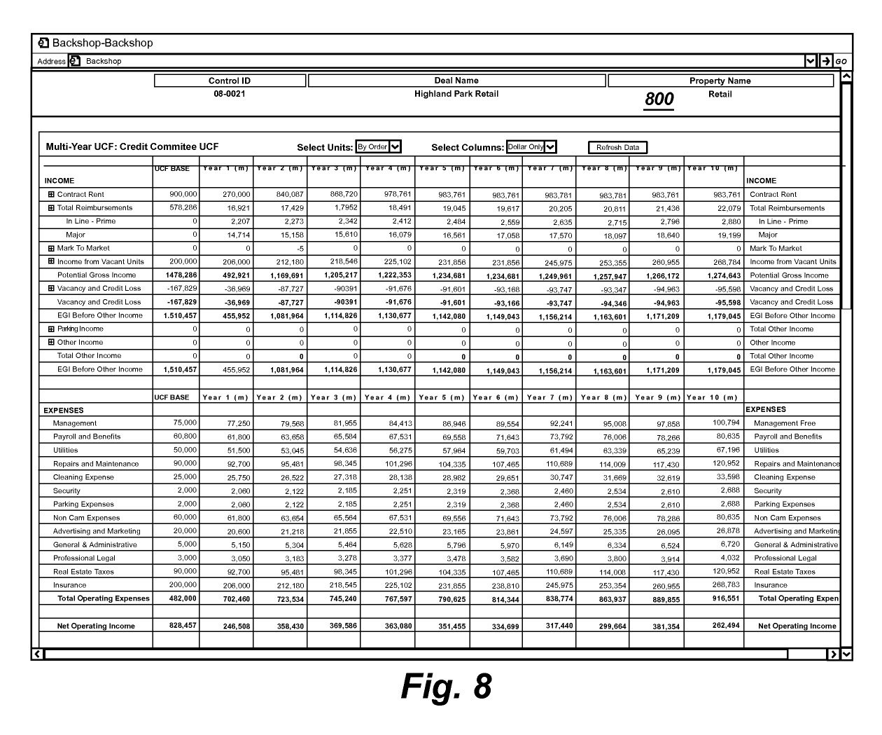

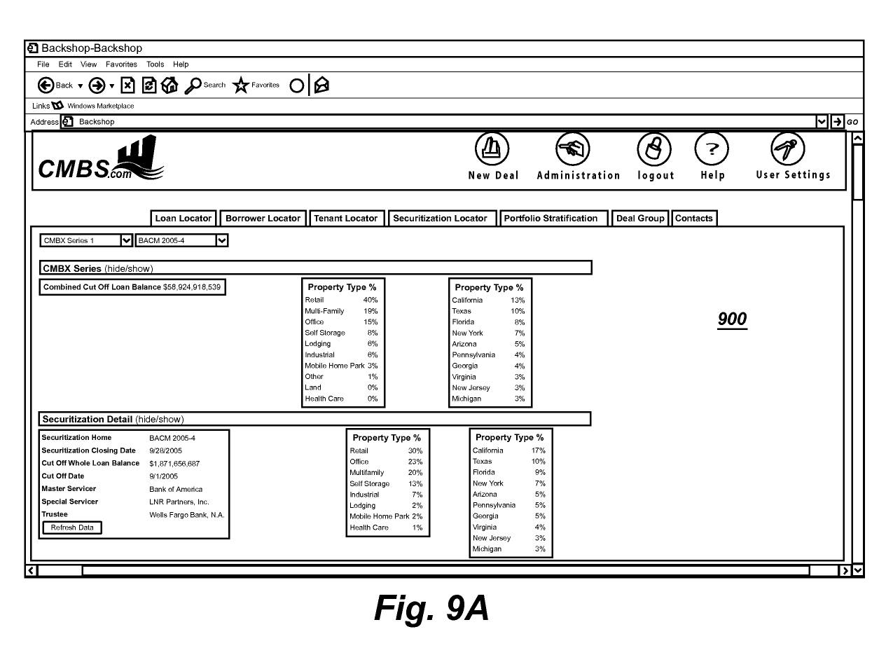

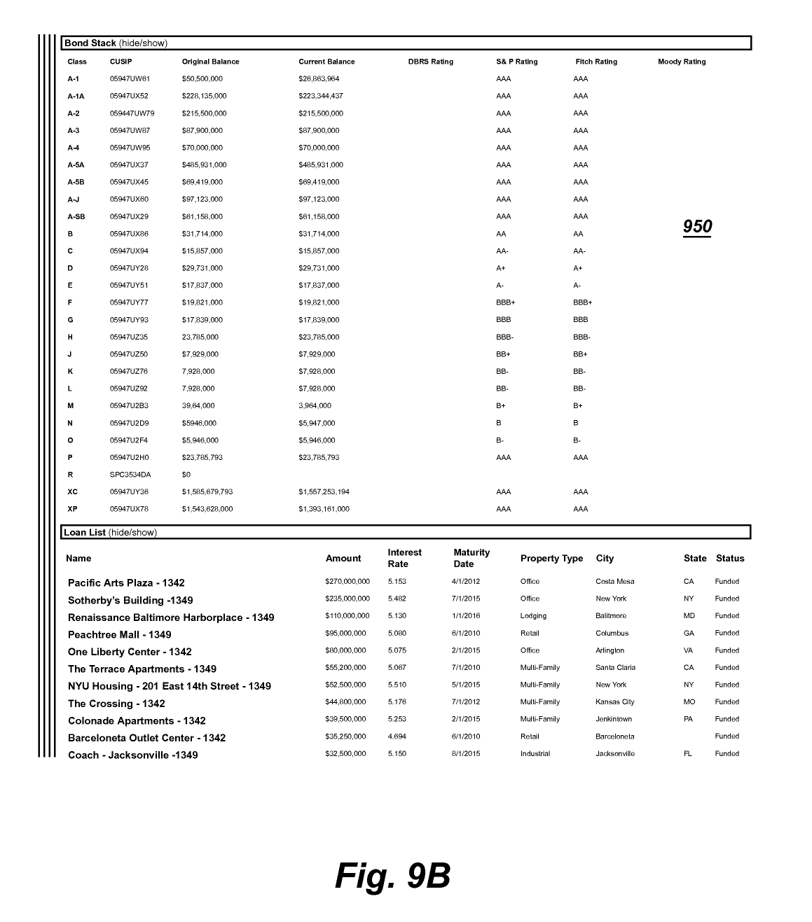

10 a deal, may be summarized by a DSCR value, FIG. 1
100 liability or Debt Service, FIG. 1
200 cash flow or assets, FIG. 1
300 Debt Service Credit Ratio (“DSCR”), FIG. 1
400 Notes interface, FIG. 2
450 Property Information interface, FIG. 3
500 Underwriting Assumption—Header interface, FIG. 4
550 Underwriting Assumption—Detail interface, FIG. 5
600 Underwritten Cash Flow (UCF) interface, FIG. 6
700 Multi Year Underwritten Assumption Details Page, FIG. 7
800 Multi Year Cash Flow Page, FIG. 8
900 Securitization Analysis Page, top half, FIG. 9A
950 Securitization Analysis Page, bottom half, FIG. 9B

### CMBS Background

Owners of commercial properties are often in need of loans. In order to draw more capital into the lending market, obtain lower interest rates, and diversify risk, owners of real estate holdings or their brokers would present large loan proposals to banks and other financial institutions. The proposed loan package could be sized, rated for risk, underwritten, closed, and packaged as a Commercial Mortgaged Backed Security (“CMBS”) instrument by the financial intuition. One of the many challenges in creating a CMBS instrument is to convert the unique aspects of multiple pieces of real property, such as unique rent rolls, vacancy projections, and the other nonfungible factors into a homogenized data structure suitable for entry into the CMBS market (specifically the rating agencies and the investors in the securities).

The income streams from the underlying commercial properties secure the value and dividends paid to holders of the CMBS instrument. The projected rates of defaulting loans are measured as investment risk and considered when the CMBS instrument is rated and priced. As a CMBS instrument is secured by multiple income streams derived from lease paying tenants of multiple properties, the lost income stream caused by a defaulting lessee should not destroy the entire value of the CMBS instrument. Many factors, including the probably or releasing the subject space is considered in the initial evaluation of a CMBS instrument. As the size and complexity of the loans and securitized pools of loans has increased, the need for tools to model the various leases and the cumulative effect the lease performance has on the loan and the pool of loans has also increased. The subject invention provides these tools through a World Wide Web technology.

In the prior art, only the largest finance companies had the necessary tools and relationships with rating agencies and investors to create CMBS instruments. The different off line systems of the various players made data transfer and shared analysis very difficult as there was no common platform for all groups to work on. The present invention overcomes shortfalls in the prior art by providing means for borrowers, lenders, rating agencies and investors to use a common World Wide Web based platform and analytical tool to create CMBS instruments.

By use of the present invention, an owner of property or a few properties, may standardize his loan request and tenant income streams so lenders can analyze the loan with the same tool as rating agencies and investors to create a standard platform for creation and analysis of the CMBS instrument. The present invention provides web interfaces, data structures, data manipulations, and financial methodologies for production of data structures, financial reports and underwriting information. By use of the present invention, the benefits of the CMBS market are now available to borrowers, lenders, rating agencies and investors that participate in the CMBS market.

A unique tool of the invention are the methodologies or underwriting assumptions used to perform the lease-by-lease cash flow analysis. As the value of any resulting CMBS instrument is directly related to the income streams from the underlying leases, a proper and complete analysis of each lease is required. The invention requires users to enter lease information and follow certain rules and guidelines to ensure the production of financial reports and data structures required for analysis into the CMBS market. By use of the disclosed underwriting methods and lease-by-lease cash flow analysis, neither property owners nor lenders are required to have the expertise and resources of the traditional participants of the CMBS market.

To open the CMBS market to the smallest of property owners and lenders, the invention presents underwriting methodologies, stored procedures, and other features wherein a novel lease-by-lease cash flow analysis method is used in modeling notes and amortization schedules, historical operating statements and rent rolls.

The general process or macro view is illustrated in FIG. 1 wherein the left hand items related to Debt Service or liability 100 may be compared the right hand items related to cash flow or assets 200 to create a Debt Service Coverage Ratio (“DSCR”) 300. Debt Service is typically the denominator and Cash Flow is the numerator in deriving a DSCR value. A “deal” 10 may be summarized as the DSCR 300 value.

The invention accommodates properties with existing or prospective loans, one or more properties, various types of tenants, and various market conditions. The questions asked of the property owner or user are straightforward and should not require independent research nor any expertise in the complex requirements of in producing CMBS instruments. The invention is practiced in a web based interface format with drop down menus and data input options.

### Existing Loans or Notes of the Underlying Properties

In an interface or methodology section sometimes referred to as “Notes” shown in FIG. 2, which shows a Notes interface 400, a property owner or user models notes, amortization schedules, prepayment terms, and exit plans. A note may reflect an existing loan or a proposed loan. The entry of multiple notes, fixed and floating rate notes, interest rate floors and locks is supported. Index values are updated automatically with current rates as the disclosed system receives updates on financial information such as interest rates.

For the creation of multiple notes with different lien positions, Lien Position and Priority buttons place or list the different loans for a property in their appropriate position. For the recording or entry of floating rate loans, a menu of the various ARM loans and Rate types may be selected. Loans with a Hold Back amount are also accommodated by the system.

The amortization or payback schedules for all existing loans are entered into the system as existing loans remain after the proposed loan enters a CMBS instrument. Careful modeling of all existing loans is required to help assess the ratio of income to debt and to assess the overall risk presented by the property and pool of properties.

### Property Details

Property details are entered into a Property Information interface 450, shown in FIG. 3 and include the entry of operating statements, rent rolls, occupancy history, ground leases and inspection reports. An Operating Statements interface allows entry of all historical statements, budgets and appraisal information.

### Rent Rolls

Rent Rolls are entered into an interface requiring a unique name for each rent roll, however, each property may have multiple rent rolls. Each rent roll requires the disclosure of the Tenant Name and Contract Rate, which is the rent called for in the lease agreement. Rent rolls may be entered manually or by uploading Excel spread sheets. Commercial and Retail rent rolls may include expense reimbursement Pro Rata detail and the creation of Tenant and Expense groups.

### Underwriting Assumptions (“UA”) and Lease-by-Lease Cash Flow Analysis

FIG. 4 is a pseudo screen shot of the Underwriting Assumption—Header interface 500 which models cash flow and various assumptions and other income stream factors that are consistent with the creation of a CMBS instrument. The disclosed methodologies lead an unsophisticated property owner or user though all steps and calculations necessary to model income streams in a truthful manor and tailored to the needs of creating a CMBS instrument. In the UA data fields, the property owner or user is given a finite number of choices in which data is entered and how that data is manipulated.

The Underwriting Assumptions (“UA”) mythologies use rent roll information and other objective criteria combined with subjective data and methodology choices selected by the user. The invention provides alternative views of the Debt Service Coverage Ratio (“DSCR”) by providing stored procedures and web based queries.

The subjective nature of DSCR may be exemplified by the dynamic nature of tenant occupancies wherein future occupancy levels and future rental rates are know as fact in the present only. Future projections of rent rolls are merely projections, and subject to subjective assumptions, but yet predictable based upon historic data. The financial summaries of the invention allow objective and subjective information to be segregated.

The Underwriting Assumptions may be related to a rent roll and the underwritten cash flow page and present such factors and/or user choices such as roll over assumptions, market rent, mark-to-market, vacancy rates and other factors as described below. The various elements, data points or considerations to the Underwriting Assumptions include the following:

### UA Name

Each UA is assigned a name, an audience and is associated with one rent roll. An audience may be a lender, investment banker or other entity. A user or property owner may set up numerous scenarios for various audiences. For example, a conservative audience may dictate restraint in certain choices such as the use of actual contract rents as opposed to higher Market Rents.

The same rent roll may not have two UAs of the same name. In proposed portfolio transactions, where more than one property is involved, the UA name is used to link the cash flow from multiple properties as Underwritten Cash Flows (“UCFs”) are one to one with UAs.

### Rental Calculation

The user may select the objective rental rate of “Actual Contract Rent” or enter a subjective assumption of “Gross Up Vacant Space at Market”. If Actual Contract Rent is selected, the Underwritten Cash Flow page will show and use the in-place contract rent when calculating Potential Gross Income (PGI). If Gross Up Vacant Space at Market is selected, vacant units are assigned revenue based upon market rents and such revenue will be displayed as “Income from Vacant Units” on the Underwritten Cash Flow (UCF) page.

### Rent to Use

The property owner or user is presented with an objective choice of Actual and subjective selections of Market and Lesser of Actual and Market. A selection of Actual results in the use of the contract rent amount. A selection of Market results the use of market rents and adjusts the contract rent by a Mark to Market, Net Operating Income (“NOI”) adjustment that may be either positive or negative. The selection of Lesser of Actual or Market takes the lesser of Actual or Market with only negative Mark to Market adjustments.

### Vacancy Factor—for Multifamily Properties Only

If Gross-Up is selected from the Rental Calculation query described above, the vacancy assumption is a straight percentage deduction. If Actual is selected from Rental Calculation, and the actual vacancy is less than the market vacancy, the vacancy adjustment is (Market Vacancy—Actual Vacancy*(Total Units/Occupied Units). If the market vacancy is less than the actual vacancy, no vacancy adjustment is made.

A Concessions data field is available for multifamily properties only. Rental concessions are entered in months and are deducted from the Contract Rent.

### Apply U/W Rent (Commercial and Retail Only)

A “yes” choice in this data field will apply the U/W rent value from UA Detail (if entered) and override the contract rent or any Mark to Market value.

### Reimbursement Calculation (Commercial and Retail Only)

This data field presents a drop down menu offering “From Rent Roll” or “From Detail”. If Rent Roll is selected, the data or value entered will be from the rent roll tenant table. If Detail is selected, the reimbursements value will be taken from the Pro Rata Expense detail section.

### Vacant Unit TI/TC (Commercial and Retail Only)

This data field presents a drop down menu offering Include or Exclude. If Include is selected, TI/LC's are applied to vacant space. If Exclude is selected, TI/LC are not calculated on vacant space.

### Unit Status

If a unit status is Excluded, all units of that status well be treated as vacant.

### Percentage Rents (Retail Only)

This data field presents a drop down menu offering “Sum from RR”, which will take the percentage rent value from rent roll tent and “From Calculated Sales” which enters the value from the amount of percentage rent paid in the year selected.

### Underwriting Assumptions—Details

The underwriting Assumptions interface includes a “Details” button available for commercial and retail properties only. An example of an Underwritten Assumption Detail “UAD” interface 550 page is shown in FIG. 5. By activating this section, a user may apply UAD or Underwriting Assumption Details to the tenants, Unit Types. The UAD for the property is initially set in the Default line. If the user desires to override any Default Assumptions, values are to be entered into the appropriate category by either Unit Type or Individual Tenant. The available values include:

Market Rent—Entered in dollars, representing the annual rant paid for the subject space.

U/W Rent—Entered in dollars, this value will override the Contract Rent and any Mark to Market if the selection “Apply Underwritten Rent” is set to yes on the UA Header.

Percentage of Percentage Rent to Include (Retail Only)—Entered as a percent, will either Gross Up or deduct the percentage rent (100% equals a zero adjustment). The adjustment will show on the UCF page as Percentage rent Adjustment.

Percentage of Reimbursements to Include—Entered as a percent, will either Gross Up or deduct the reimbursements if they come from rent roll (100% equals a zero adjustment). The adjustment will show on the UCF page as Expense Reimbursement Adjustment.

Vacancy—Entered as a percent and represents the market vacancy.

Renewal Probability—Entered in percent and represents the probability of the existing tenants renewing their leases at the market rate.

Average Lease Term—Entered in months and represents the length of the existing tenants renewing their leases at the market rate.

TI New and TI Renewal—Entered as a dollar value per square foot and represents the market amount of Tenant Improvements for new and renewal leases.

LC New and LC Renewal—Entered as a dollar value per square foot or a percentage of the lease value and represents the market amount of Leasing Commissions for new and renewal leases.

Reserves—Entered as a dollar value and represents the capital reserve per square foot per year.

### Transitional Calculations

After the assumptions have been entered into the system a button or option will appear on the UA page as “Transitional Calcs”. By clicking or otherwise activation of the option, the lease-by-lease effects of the entered assumptions will be displayed.

### Underwritten Cash Flow or “UCF”

An example of an Underwritten Cash Flow “UCF” interface 600 page is shown in FIG. 6. UCF pages are one to one with Underwriting Assumptions. Each Underwriting Assumption has one and only one associated UCF that may be copied, deleted or edited. For new UCF pages, the user may select the historical operating statements to be associated with the UCF and the order in which they will appear. The value of each UCF line may be entered manually (M), by a formula based upon a percentage of an income category or dollars per square foot (F), average of historical periods (A), a summary average of the detail of each section (S), or the value calculated through the underwriting assumptions tied to the rent roll (R).

The DSCR calculated at the bottom of the page or interface reflects the subject property's Net Cash Flow “NCF” over the total debt service from all included notes. Footnotes or other commentary may be added to any data field. Only Net Operating Income (NOI)

Categories that are part of the included historical operating statements appear on the UCF interface. Additional NOI categories may be added for the UCF column.

All UCF of similar property types roll up in detail. UCF of different property types may be rolled up in summary form. By activating the Income RR to UCF or the Capital RR to UCF buttons, the system will set the Automated Calculation (Auto Calc) value for all income and capital fields to “R” (from rent roll). Any NOI category with an adjacent “+” contains more detail by Unit Type. UCF's and other aspects of the system may be exported to Excel or other data formats.

### Multi Year Underwritten Cash Flow (MYUCF)

MYUCF Pages and Assumptions are one to one with Underwriting Assumptions in that each UA has one associated UCF and one MYUCF. For new MYUCF scenarios, the user may select the UA/UCF and set assumptions such as Number of Years for the analysis, Year of Sale, Discount Rate, Cap Rate, and Cost of Sales.

After creating a new MYUCF data set, the user may set various Rent and Roll Over Assumptions for the projected cash flow. An example of an Multi Year Underwritten Assumption Detail “MYUAD” page 700 is shown in FIG. 7. Such assumptions include:
1. Market Rent Growth—This amount is entered as a percent and will increase the Market rental rate by the percentage entered.
2. Underwritten Rent Growth—This amount is entered as a percentage and will increase the Underwritten Rent (if used) by the entered percentage.
3. Down Time between Leases—The amount of time, entered in months, which a rental space will be vacant after a tenant departs.
4. Roll Over Lease Type—This data field is active only if the UAH Reimbursement Calculation field is set to “From Detail”. This filed determines what reimbursements new tenants will pay to acquire a new leasehold. Three settings for this data field include: “NNN” (new tenant will pay 100% of their Pro Rata expenses), “Modified Gross” (tenant will pay their Pro Rata share of expenses above the actual expenses in the roll over year, and “Gross” (new tenants do not pay any expense reimbursements).
5. TI New, TI Renewal, LC New, LC Renewal and Cap Ex—Are growth factors, entered as percentages and will increase the inputted values by the entered value.
6. Growth Factor Assumptions—Allows the setting of growth factors for “Other Income” categories, such as parking income, percentage rents, and other income streams. If the UAH Reimbursement Calculation is set to “From Rent Roll”, the user may select Reimbursements from either the Rent Roll or the UCF column. If the Rent Roll is selected, the Reimbursements will be increased by the entered grown factor but will drop when a tenant departs. If “UCF is selected, the reimbursement will be factored from the amount entered on the Base UCF for the selected length of the analysis.
7. Expense Assumptions—Allows the setting of growth factors for the expenses. Selections include “Growth” (the user enters one value to increase the expense by the entered rate), “Growth Custom” (the user enters an individual growth rate per year), and “Formula” (wherein expense is calculated as a percentage of either EFI, PGI, or Contract Rent.

### Multi Year Underwritten Cash Flow

After populating a MYUCF data set with assumptions, a multi year cash flow analysis may be displayed. A multi year cash flow may be displayed in numerous formats, including dollars or values and per unit/percent columns or in dollar values. An example of an Multi Year Cash Flow Page 800 “MYUCF” page is shown in FIG. 8. The various views include:
1. Month by Month Detail
2. Vacancy Adjustments/Roll Over overrides
3. Printing Cash Flows and Assumptions: The user may select various options for printing the cash flow and the assumptions, such options include:
   a) Export Summary—Produces the cash flow without including the detail level of Unit Type and Expense Reimbursements.
   b) Export All—Produces the cash flow with all detail by Unit Type and Reimbursements Types/Amounts.
   c) The Assumption page may be the same for both the Summary and the Detailed sections.

### Securitization Analysis

After creating cash flow models at the loan level, these cash flow scenarios are aggregated at the securitization level. Each cash flow scenario will imply certain default scenarios and the predicted loan losses are applied to the capital structure of the underlying CMBS instruments. Depending on the cash flow scenario selected, the loss, and therefore the value, of the bonds can be determined. An example of a Securitization Analysis page is shown in FIGS. 9A and 9B. In FIG. 9A, the top half 900 of a Securitization Analysis page lists percentages of property locations, property types and other information. In FIG. 9B, the bottom half 950 of a Securitization Analysis page lists S & P ratings and other qualitative analysis.

The invention includes, but is not limited to the following items:

### Items:

1. A method of calculating underwriting assumptions for proposed loans, the method comprising the steps of:
   a) assigning a name or other identifier to each commercial property;
   b) associating one rent roll to each underwriting;
   c) presenting a rental calculation method by allowing entry of either Actual Contract Rent or Gross Up Vacant Space at Market;
      i. if Actual Contract Rent is selected, only in-place contract rent will be used in calculating Potential Gross Income;
      ii. if Gross Up Vacant Space at Market is selected, vacant units are assigned revenue based upon market rents and the resulting revenue is labeled Income from Vacant Units;
   d) presenting a rental rate or Rate to Use as either being Actual, Market, or Lesser of Actual Market wherein:
      i. Actual uses the amount of contract rent;
      ii. Market uses a market rents and adjusts the contract rent by a Mark to Market NOI adjustment;
      iii. Lesser of Actual Market uses the lesser of Actual or Market.
2. The method of item 1 used for multifamily properties wherein in the presentation of rental calculation:
a) if Gross Up Vacant Space at Market is selected, the vacancy assumption is a straight percentage deduction; or
b) if Actual is selected, and the actual vacancy is less than market vacancy, the vacancy adjustment is (Market Vacancy—Actual Vacancy)*(Total Units/Occupied Units), if market vacancy is less than actual vacancy, no vacancy adjustment is made.
3. The method of item 1 wherein for commercial or retail properties a Reimbursement calculation may be chosen form a Rent Roll method or from a Detail method such that:
   a) if Rent Roll is selected, the values are from the rent roll tenant table; or
   b) if Detail is selected, the reimbursements are taken from the Pro Rata Expense detail section.
4. The method of item 1 wherein underwriting assumptions applied to tenants, Unit Types may be over ridden by either Unit Type or Individual tenant by a plurality of values.
5. The method of item 4 wherein the plurality of values include:
   a) Market Rent
   b) U/W Rent
   c) Percent of Percentage Rent to Include
   d) Vacancy
   e) Average Lease Term
   f) Renewal Probability;
   g) TI New and TI Renewal;
   h) LC New and LC Renewal; and
   i) Reserves.
6. A method of calculating multiyear underwritten cash flows comprising the steps of selecting:
   a) number of years for the analysis;
   b) year of sale;
   c) discount rate;
   d) cap rate;
   e) cost of sales
7. The method of item 6 including the steps of selecting rental and roll over assumptions that include:
   a) market rent growth;
   b) underwritten rent growth amount;
   c) down time between leases; and
   d) roll over lease type.
8. The method of item 7 wherein the rental and roll over assumptions to be selected include TI New, TI Renewal, LC New, LC Renewal and Cap Ex.
9. The method of item 8 wherein the rental and roll over assumptions of claim 8 are entered as percentages.
10. A method of underwriting a proposed loan for later use in the Commercial Mortgaged Backed Securities (CMBS) instrument wherein the rental rates and vacancy rates may be calculated as the actual in place rates or calculated as projected market rates.
11. The method of item 10 wherein a Debt Service Credit Ratio (DSCR) may be calculated by use of either actual in place rates or projected market rates.
12. The method of item 11 wherein actual in place rental and vacancy rates are stored and displayed for one targeted audience and projected market rental and vacancy rates are stored and displayed for a different target audience.
13. The method of item 11 wherein both objective and subjective factors may be used in calculating a DSCR.
14. The method of item 13 wherein combinations of objective and subjective factors may be used and displayed in calculating a DSCR.
15. The method of item 14 used by 3 parties to evaluate the risk of the underlying cash flow and the effect that the strength or weakness of that cash flow will have on the loan, on the pool of loans in the securitization, and the CMBS securities themselves.

What is claimed is:

1. A method of calculating underwriting assumptions for proposed loans, the method comprising the steps of:
a) assigning a name or other identifier to each commercial property;
b) associating one rent roll to each underwriting;
c) presenting a rental calculation method by allowing entry of either Actual Contract Rent or Gross Up Vacant Space at Market;
i. if Actual Contract Rent is selected, only in-place contract rent will be used in calculating Potential Gross Income;
ii. if Gross Up Vacant Space at Market is selected, vacant units are assigned revenue based upon market rents and the resulting revenue is labeled Income from Vacant Units;
d) presenting a rental rate or Rate to Use as either being Actual, Market, or Lesser of Actual Market wherein:
i. Actual uses the amount of contract rent;
ii. Market uses a market rents and adjusts the contract rent by a Mark to Market NOI adjustment; and
iii. Lesser of Actual Market uses the lesser of Actual or Market.

2. The method of claim 1 used for multifamily properties wherein in the presentation of rental calculation:
a) if Gross Up Vacant Space at Market is selected, the vacancy assumption is a straight percentage deduction; or
b) if Actual is selected, and the actual vacancy is less than market vacancy, the vacancy adjustment is (Market Vacancy—Actual Vacancy)*(Total Units/Occupied Units), if market vacancy is less than actual vacancy, no vacancy adjustment is made.

3. The method of claim 1 wherein for commercial or retail properties a Reimbursement calculation may be chosen form a Rent Roll method or from a Detail method such that:
a) if Rent Roll is selected, the values are from the rent roll tenant table; or
b) if Detail is selected, the reimbursements are taken from the Pro Rata Expense detail section.

4. The method of claim 1 wherein underwriting assumptions applied to tenants, Unit Types may be over ridden by either Unit Type or Individual tenant by a plurality of values.

5. The method of claim 4 wherein the plurality of values include:
a) Market Rent
b) U/W Rent
c) Percent of Percentage Rent to Include
d) Vacancy
e) Average Lease Term
f) Renewal Probability;
g) TI New and TI Renewal;
h) LC New and LC Renewal; and
i) Reserves.

6. A method of calculating multi year underwritten cash flows comprising the steps of selecting:
a) number of years for the analysis;
b) year of sale;
c) discount rate;
d) cap rate; and
e) cost of sales

7. The method of claim 6 including the steps of selecting rental and roll over assumptions that include:
a) market rent growth;
b) underwritten rent growth amount;
c) down time between leases; and
d) roll over lease type.

8. The method of claim 7 wherein the rental and roll over assumptions to be selected include TI New, TI Renewal, LC New, LC Renewal and Cap Ex.

9. The method of claim 8 wherein the rental and roll over assumptions of claim 8 are entered as percentages.

10. A method of underwriting a proposed loan for later use in the Commercial Mortgaged Backed Securities (CMBS) instrument wherein the rental rates and vacancy rates may be calculated as the actual in place rates or calculated as projected market rates.

11. The method of claim 10 wherein a Debt Service Credit Ratio (DSCR) may be calculated by use of either actual in place rates or projected market rates.

12. The method of claim 11 wherein actual in place rental and vacancy rates are stored and displayed for one targeted audience and projected market rental and vacancy rates are stored and displayed for a different target audience.

13. The method of claim 11 wherein both objective and subjective factors may be used in calculating a DSCR.

14. The method of claim 13 wherein combinations of objective and subjective factors may be used and displayed in calculating a DSCR.

15. The method of claim 14 used by 3^{rd} parties to evaluate the risk of the underlying cash flow and the effect that the strength or weakness of that cash flow will have on the loan, on the pool of loans in the securitization, and the CMBS securities themselves.
